(19) United States
(12) Patent Application Publication
(10) Pub. No.: US 2009/0058553 A1
(43) Pub. Date: Mar. 5, 2009

(54) Non-reflective SPNT switch

(76) Inventor: Zeji Gu, Lexington, MA (US)

Correspondence Address: JOYCE E. LAUER, 75 MOORE ROAD, WAYLAND, MA, 01778, US

(21) Appl. No.: 12/231,380

(22) Filed: Sep. 2, 2008

Related U.S. Application Data
(60) Provisional application No. 60/967,403, filed on Sep. 4, 2007.

(51) Int. Cl. H01P 1/10

(52) U.S. Cl. 333/101; 333/103

(57) ABSTRACT

A non-reflective SPNT switching device comprises one pole, at least three throws, a plurality of main switches, and a plurality of bridge switches. The bridge switches enable all throws to be non-reflective. Each main switch is coupled between the pole and one of the throws. One main switch has a first (eg ON) state, the one main switch being coupled to an active throw in a conducting signal path, and each other main switch has a second (eg OFF) state. Each throw is operably coupled to first and second adjacent throws through first and second adjacent bridge switches. For the active throw, the first and second bridge switches have the second state. For each non-active throw, one of the adjacent bridge switches has the first (eg ON) state and one of the adjacent bridge switches has the second state.

### CROSS-REFERENCE TO RELATED APPLICATIONS

The present application claims the benefit under 35 U.S.C. §119 of Provisional Application No. 60/967,403, filed Sep. 4, 2007. The above-referenced application is incorporated by reference herein.

### BACKGROUND

In a single pole multiple throw (SPNT) switch, a signal path between the pole and any one of the N throws may be in a conductive (ON) or non-conductive (OFF) state. At a given time, only one signal path is in the ON state and all other signal paths are in the OFF state. The pole and throw that are in the ON state signal path may have good impedance matching, resulting in minimal signal reflection and a low voltage stopping wave ratio (VSWR). The throws that are in the OFF state signal paths may have unmatched impedance, resulting in high reflection and high VSWR. For many switch applications it is desirable to have good impedance matching and low reflection in all of the signal paths, including the signal paths that are in the OFF state. A switch with these characteristics is called a non-reflective (or absorptive or terminated) switch.

### SUMMARY

A non-reflective SPNT switching device comprises one pole, at least three throws, a plurality of main switches, and a plurality of bridge switches. The bridge switches enable all throws to be non-reflective throughout a wide frequency range. Each main switch is coupled between the pole and one of the throws. One main switch has a first (eg ON) state, the one main switch being coupled to an active throw in a conducting signal path, and each other main switch has a second (eg OFF) state. Each throw is operably coupled to first and second adjacent throws through first and second adjacent bridge switches. For the active throw, the first and second bridge switches have the second state. For each non-active throw, one of the adjacent bridge switches has the first (eg ON) state and one of the adjacent bridge switches has the second state.

Additional embodiments are described in the detailed description below. This summary does not purport to define the invention. The invention is defined by the claims.

### BRIEF DESCRIPTION OF THE DRAWINGS

FIG. 1 depicts a non-reflective SP3T switching device comprising one pole, three throws, three main switches, and three bridge switches.

FIG. 2 depicts a non-reflective SP5T switching device comprising one pole, five throws, five main switches, and five bridge switches.

FIG. 3 depicts states for the main switches and the bridge switches in the SP3T switching device of FIG. 1.

FIG. 4 depicts states for the main switches and the bridge switches in the SP5T switching device of FIG. 2.

FIG. 5 depicts control signals and bridge control signals for the main switches and the bridge switches in the SP3T switching device of FIG. 1.

FIG. 6 depicts control signals and bridge control signals for the main switches and the bridge switches in the SP5T switching device of FIG. 2.

FIG. 7 depicts control signals and bridge control signals for the main switches and the bridge switches in the SP3T switching device of FIG. 1.

FIG. 8 depicts control signals and bridge control signals for the main switches and the bridge switches in the SP5T switching device of FIG. 2.

FIG. 9 depicts control signals and bridge control signals for the main switches and the bridge switches in a non-reflective SP7T switching device.

FIG. 10 depicts a bridge switch comprising a switching element and a logic gate that receives three bridge control signals.

FIG. 11 depicts a termination that includes a resistor and a capacitor.

FIG. 12 depicts control signals and bridge control signals for the main switches and the bridge switches in the SP3T switching device of FIG. 1.

FIG. 13 depicts control signals and bridge control signals for the main switches and the bridge switches in the SP5T switching device of FIG. 2.

FIG. 14 depicts a bridge switch having a series-only configuration.

FIG. 15 depicts a non-reflective SP3T switching device that uses multigate transistors for the main switches and the bridge switches.

FIG. 16 depicts a bridge switch having a series-shunt-series configuration.

FIG. 17 depicts a non-reflective SP3T switching device that uses variable shunts combined with transmission lines for the bridge switches.

FIG. 18 depicts a non-reflective SP5T switching device that uses a combination of bridge switches and terminations for non-reflectivity.

FIG. 19 depicts a non-reflective SP8T switching device that uses a combination of bridge switches and terminations for non-reflectivity.

### DETAILED DESCRIPTION

Reference will now be made in detail to some embodiments, examples of which are illustrated in the accompanying drawings. In this description and in the appended claims, the terms ‘a’ or ‘an’ are used, as is common in patent documents, to include one or more than one. In this description and in the appended claims, the term ‘or’ is used to refer to a nonexclusive or, unless otherwise indicated.

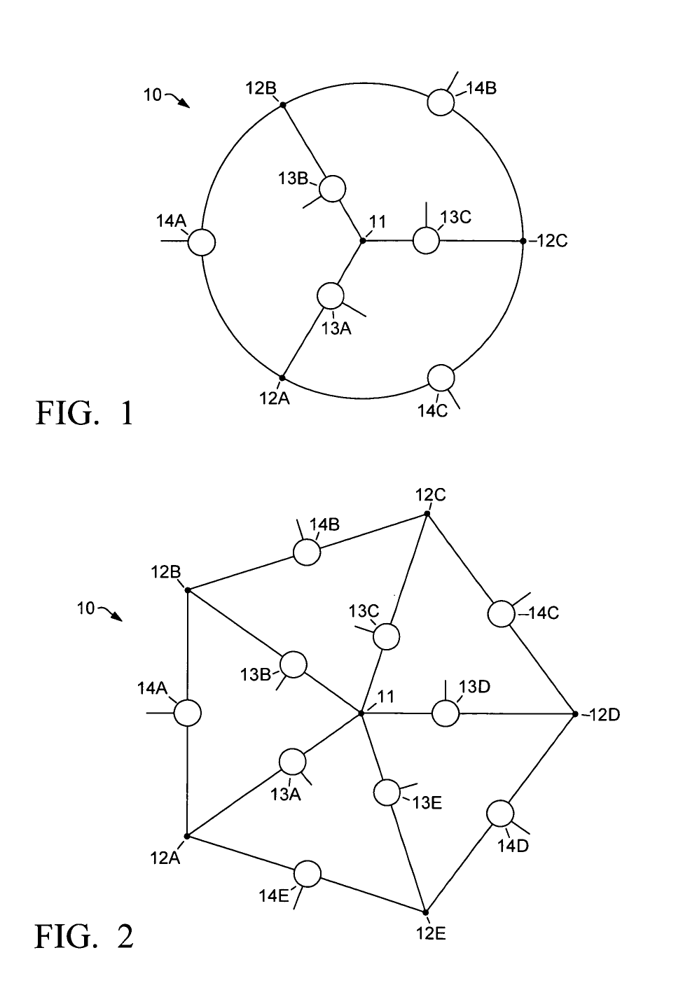

FIG. 1 depicts a non-reflective SP3T switching device 10 comprising one pole 11, three throws 12, three main switches 13, and three bridge switches 14, in accordance with an embodiment. In the embodiment of FIG. 1, the throw count (number of throws 12) is three, the main switch count (number of main switches 13) equals the throw count, and the bridge switch count (number of bridge switches 14) equals the throw count. Each main switch 13 is coupled between the pole 11 and one of the throws 12. For example, main switch 13B is coupled between pole 11 and throw 12B. Each throw 12 has a first adjacent throw 12 and a second adjacent throw 12. For example, for throw 12B the adjacent throws are throws 12A and 12C. For each throw 12, the throw 12 is operably coupled to the first adjacent throw 12 through a first adjacent bridge switch 14 and is operably coupled to the second adjacent throw 12 through a second adjacent bridge switch 14. For example, throw 12B is operably coupled to adjacent throw 12A through adjacent bridge switch 14A, and throw 12B is operably coupled to adjacent throw 12C through adjacent bridge switch 14B. For each bridge switch 14, the throws 12 that are coupled to the bridge switch 14 are called flanking throws 12. For example, bridge switch 14A is coupled to flanking throws 12B and 12A.

FIG. 2 depicts a non-reflective SP5T switching device 10 comprising one pole 11, five throws 12, five main switches 13, and five bridge switches 14, in accordance with an embodiment. Except for the different numbers of throws 12, main switches 13, and bridge switches 14, the embodiment of FIG. 2 is similar to that of FIG. 1. In other embodiments, a switching device 10 may have different numbers of throws 12, main switches 13, and bridge switches 14.

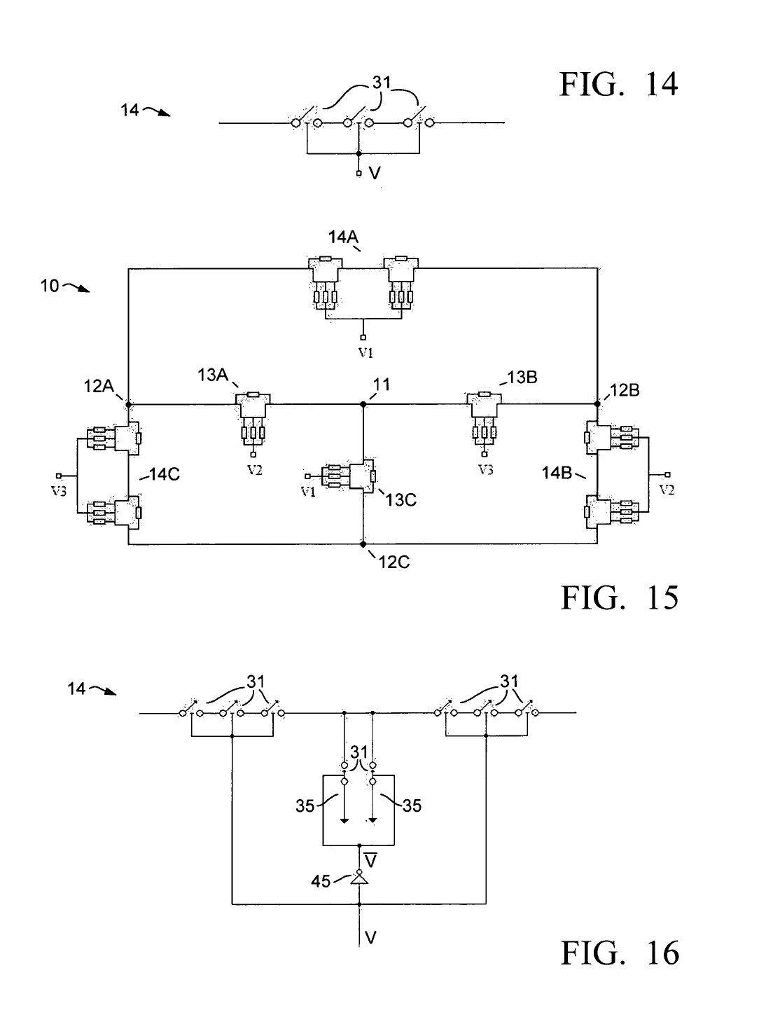

In this description and in the appended claims, the adjectives “main” and “bridge” are used to indicate the locations of switches, and these adjectives do not imply any special attributes for a main switch 13 or a bridge switch 14. A main switch 13 is a switch that is coupled between the pole 11 and a throw 12, and a bridge switch 14 is a switch that is coupled between two throws 12. As described below in connection with FIGS. 14-17, an individual main switch 13 or bridge switch 14 may be realized using plural switching elements and other circuit elements. In this description and in the appended claims, a statement that a specific main switch 13 or a specific bridge switch 14 is “coupled to” or “connected to” a specific pole 11 or a specific throw 12 means that no other main switch 13, bridge switch 14, pole 11, or throw 12 is positioned between the specific main switch 13 or the specific bridge switch 14 and the specific pole 11 or the specific throw 12; the specific main switch 13 or specific bridge switch 14 may be coupled to the specific pole 11 or specific throw 12 through a circuit element such as a capacitor.

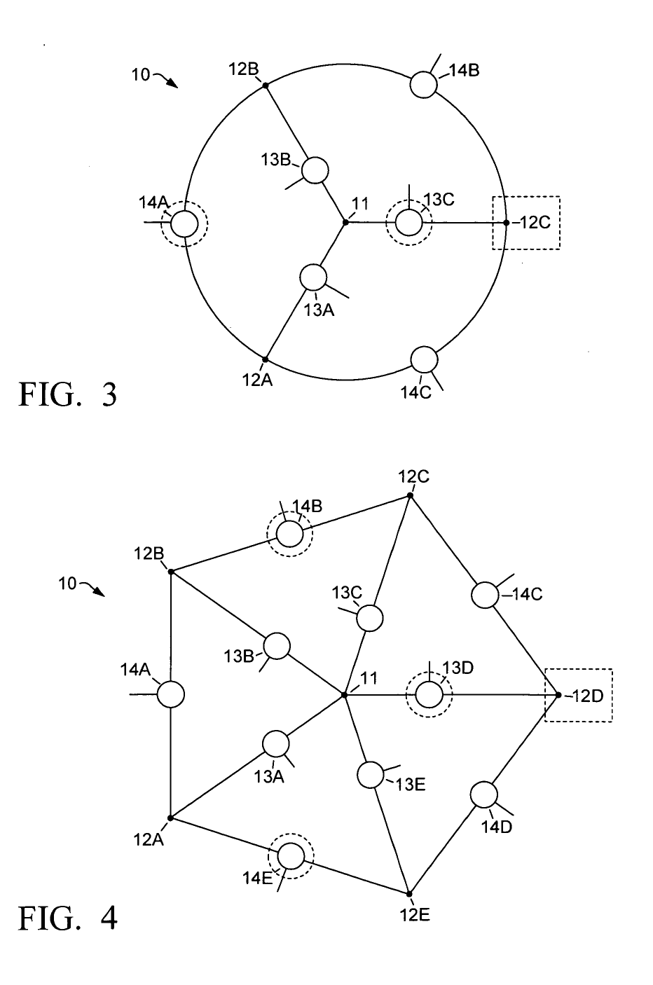

FIG. 3 depicts a set of states for the main switches 13 and the bridge switches 14 in the SP3T switching device 10 of FIG. 1, in accordance with an embodiment. There are two states, a first state and a second state. The two states may correspond to, for example, ON and OFF conditions. In the embodiment of FIG. 3, one main switch 13C has a first state (dashed circle indicates first state) and is coupled to an active throw 12C (dashed rectangle indicates active throw). The active throw 12 is the one throw 12 that is coupled to the one main switch 13 that is in the ON condition. Each other main switch 13A,13B has a second state (absence of dashed circle indicates second state). For the active throw 12C, the adjacent bridge switches 14B and 14C both have the second state. For each of the other throws 12B and 12A, both of which are non-active throws 12, one of the adjacent bridge switches 14 has the first state and one of the adjacent bridge switches 14 has the second state. Thus for throw 12B, adjacent bridge switch 14A has the first state and adjacent bridge switch 14B has the second state. For throw 12A, adjacent bridge switch 14A has the first state and adjacent bridge switch 14C has the second state.

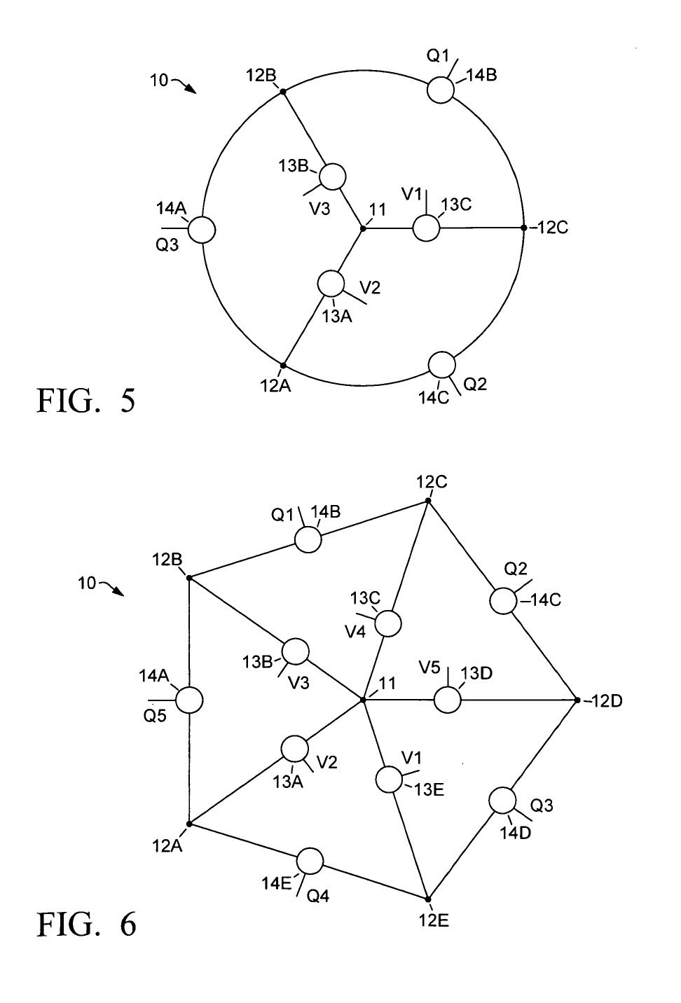

The set of states depicted in FIG. 3 represents a snapshot in time for the states of switches within switching device 10. At another time, a different set of states may exist. Table 1 indicates the three possible sets of states for the main switches 13 and the bridge switches 14 in the embodiment of FIG. 3. The abbreviation “act” indicates that an individual throw 12 is the active throw. For the main switches 13 and the bridge switches 14, a plus symbol (+) indicates the first state and a minus symbol (−) indicates the second state. The states of individual main switches 13 and bridge switches 14 may be set using control signals and bridge control signals, as described in connection with FIGS. 5-17.

TABLE 1

| | 12A | 12B | 12C | 13A | 13B | 13C | 14A | 14B | 14C |
|---|---|---|---|---|---|---|---|---|---|
| 1 | − | − | act | − | − | + | + | − | − |
| 2 | act | − | − | + | − | − | − | + | − |
| 3 | − | act | − | − | + | − | − | − | + |

The non-reflective behavior of the pole 11 and throws 12 in the switching device 10 of FIG. 3 results from the coordination of the states of the bridge switches 14 and the main switches 13. An individual throw 12 is coupled to three switches, one main switch 13 and two bridge switches 14. If a single one of the three switches is in the ON condition, this creates a circuit with reasonably matched impedances, resulting in minimal reflection. If a throw 12 is the active throw, it is coupled to the pole 11 through a main switch 13 that is in the ON condition, resulting in minimal reflection for both the pole 11 and the active throw 12. If a throw 12 is a non-active throw, it may be coupled to another non-active throw 12 through a bridge switch 14 that is in the ON condition, resulting in minimal reflection. In other words, reflection may be minimized if each non-active throw 12 is paired with another non-active throw 12 by coupling through a bridge switch 14 that is in the ON condition. If the bridge switches 14 were omitted from the structure depicted in FIG. 3, or if all of the bridge switches 14 were in the OFF condition, then that structure or set of states would behave like a simple star-topology SPNT switching device. In a simple star-topology switching device, with one main switch 13 in the ON condition and each other main switch 13 in the OFF condition, all but one of the throws 12 are reflective. The pole 11 is non-reflective, and the active throw 12 is non-reflective, but all of the other (non-active) throws 12 are reflective.

In the non-reflective switching device 10 of FIG. 3, neither throw 12B or throw 12A is coupled to a main switch 13 that is in the ON condition; in other words, throws 12B and 12A are non-active throws 12. Nevertheless, throws 12B and 12A are non-reflective because bridge switch 14A, which is coupled between throws 12B and 12A, is in the ON condition. Coupling of throws 12B and 12A through bridge switch 14A creates a circuit with reasonably matched impedances, resulting in minimal reflection. Coordination of the ON/OFF states of the main switches 13 and the bridge switches 14 results in a non-reflective SPNT switching device 10.

FIG. 4 depicts states for the main switches 13 and the bridge switches 14 in the SP5T switching device 10 of FIG. 2, in accordance with an embodiment. Except for the different numbers of throws 12, main switches 13, and bridge switches 14, the embodiment of FIG. 4 is similar to that of FIG. 3. As in the embodiment of FIG. 3, a dashed circle indicates the first state, absence of a dashed circle indicates the second state, and a dashed rectangle indicates the active throw 12. Table 2 indicates the five possible sets of states for the main switches 13 and the bridge switches 14 in the embodiment of FIG. 4. The abbreviation “act” indicates that an individual throw 12 is the active throw. For the main switches 13 and the bridge switches 14, a plus symbol (+) indicates the first state and a minus symbol (−) indicates the second state.

TABLE 2

| | 12A | 12B | 12C | 12D | 12E | 13A | 13B | 13C | 13D | 13E | 14A | 14B | 14C | 14D | 14E |
|---|---|---|---|---|---|---|---|---|---|---|---|---|---|---|---|
| 1 | − | − | − | act | − | − | − | − | + | − | − | + | − | − | + |
| 2 | − | − | − | − | act | − | − | − | − | + | + | − | + | − | − |
| 3 | act | − | − | − | − | + | − | − | − | − | − | + | − | + | − |
| 4 | − | act | − | − | − | − | + | − | − | − | − | − | + | − | + |
| 5 | − | − | act | − | − | − | − | + | − | − | + | − | − | + | − |

The embodiments of FIGS. 1-4 each comprise an odd number N of throws 12. In other words, a count N for the throws 12 is an odd integer. The reason for the odd number N is the following. When N is an odd number, there is one active throw 12 plus an even number P of non-active throws 12. The P non-active throws 12 may be grouped into P/2 pairs. As described in connection with FIG. 3, reflection may be minimized if each non-active throw 12 is paired with another non-active throw 12 by coupling through a bridge switch 14 that is in the ON condition. For pairing of non-active throws 12, there should be an even number of non-active throws 12. For practical applications, it is simple to circumvent the restriction to odd numbers of throws 12 as follows. For non-reflective switch applications that use an even number N of throws 12, a non-reflective switching device 10 having N+1 throws 12 may be substituted, with one of the N throws 12 not being used (never active). Thus SPNT applications that use any number N of throws 12, where N is either even or odd, may be accomplished using embodiments described herein.

FIG. 5 depicts control signals V1-V3 and bridge control signals Q1-Q3 for the main switches 13 and the bridge switches 14 in the SP3T switching device 10 of FIG. 1, in accordance with an embodiment. Control signals V1-V3 control the ON/OFF state for main switches 13, and bridge control signals Q1-Q3 control the ON/OFF state for bridge switches 14. Each main switch 13 receives a control signal V, and the control signal V is separate for each main switch 13. Thus, main switch 13A receives control signal V2, main switch 13B receives control signal V3, and main switch 13C receives control signal V1. Each bridge control signal Q1-Q3 is separate from each control signal V1-V3. Bridge switch 14A receives bridge control signal Q3, bridge switch 14B receives bridge control signal Q1, and bridge switch 14C receives bridge control signal Q2.

FIG. 6 depicts control signals V1-V5 and bridge control signals Q1-Q5 for the main switches 13 and the bridge switches 14 in the SP5T switching device 10 of FIG. 2, in accordance with an embodiment. Except for the different numbers of throws 12, main switches 13, bridge switches 14, control signals V, and bridge control signals Q, the embodiment of FIG. 2 is similar to that of FIG. 1. Each bridge control signal Q1-Q5 is separate from each control signal V1-V5.

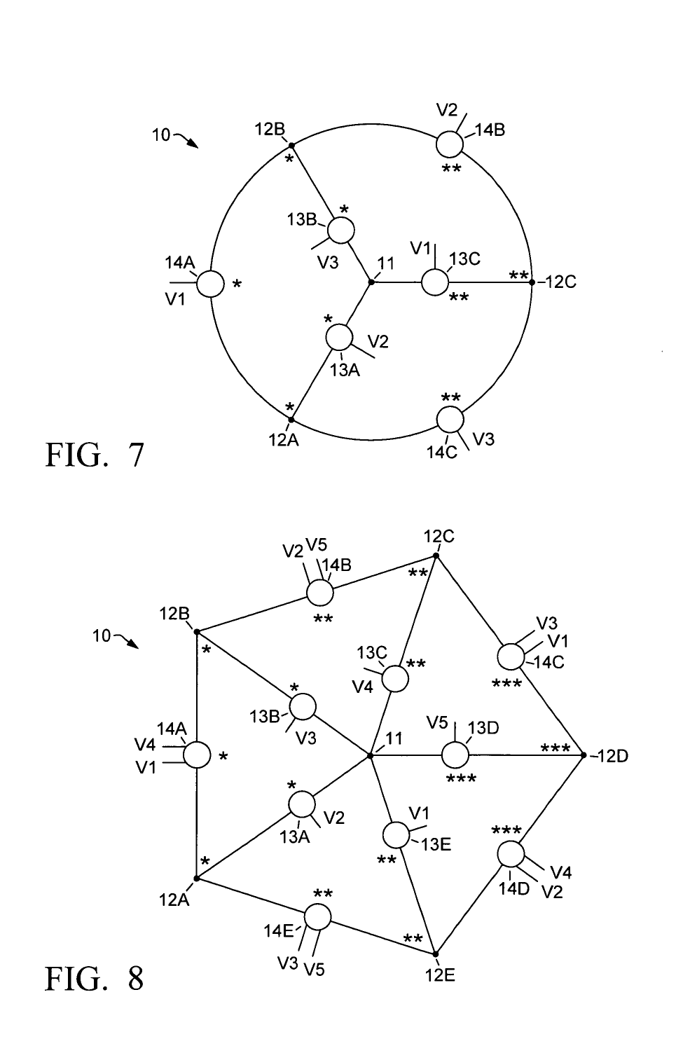

FIG. 7 depicts control signals V1-V3 and bridge control signals V1-V3 for the main switches 13 and the bridge switches 14 in the SP3T switching device 10 of FIG. 1, in accordance with an embodiment. As in the embodiment of FIG. 5, each main switch 13 receives a control signal V, and the control signal V is separate for each main switch 13. Signals V1-V3 serve to control the main switches 13 and also the bridge switches 14; in other words, each bridge control signal V1-V3 is one of the control signals V1-V3. FIG. 8 depicts control signals V1-V5 and bridge control signals V1-V5 for the main switches 13 and the bridge switches 14 in the SP5T switching device 10 of FIG. 2, in accordance with an embodiment. Except for the different numbers of elements, the embodiment of FIG. 8 is similar to that of FIG. 7. Each bridge switch 14 receives at least one bridge control signal V. In the SP3T switching device 10 of FIG. 7, each bridge switch 14 receives one bridge control signal V. In the SP5T switching device of FIG. 8, each bridge switch 14 receives two bridge control signals V.

The specific bridge control signal or signals V that are received by each bridge switch 14 is explained here for the example of bridge switch 14A in the embodiment of FIG. 7. Bridge switch 14A and main switch 13C both receive control signal V1. Thus, main switch 13C and bridge switch 14A may be controlled together, so that both switches are ON or OFF at the same time. What is the reason for coordinating the ON/OFF state of main switch 13C and bridge switch 14A? Referring to FIG. 3, note that main switch 13C and bridge switch 14A both have the first state (eg ON condition) at a time when main switches 13A,13B and bridge switches 14B,14C have the second state (eg OFF condition). As described in connection with FIG. 3, the non-reflective behavior of the switching device 10 of FIG. 3 results from the coordination of the states of the bridge switches 14 and the main switches 13.

In FIGS. 7 and 8, asterisk symbols are used to mark each throw 12, main switch 13, and bridge switch 14. A single asterisk (*) indicates a primary element, two asterisks (**) indicate a secondary element, and three asterisks (***) indicate a tertiary element. Continuing with the example of bridge switch 14A in FIG. 7, we designate it to be the primary bridge switch 14, as indicated by the single asterisk. Flanking throws 12A and 12B and coupled main switches 13A and 13B are also primary elements, as indicated by the single asterisk. More distant from bridge switch 14A are the secondary elements which are marked with two asterisks. The secondary elements include bridge switches 14B and 14C, throw 12C, and main switch 13C. Main switch 13C is thus a secondary main switch 13 with respect to bridge switch 14A, and control signal V1 that is received by main switch 13C is thus a secondary control signal with respect to bridge switch 14A. Similarly in FIG. 8, asterisk symbols indicate primary, secondary, and tertiary elements with respect to bridge switch 14A.

Using the terminology of primary and secondary elements, we can state a more general rule that describes the association of a control signal V with a bridge switch 14. Each bridge switch 14 receives at least one bridge control signal V, and the at least one bridge control signal V comprises a secondary control signal V. The secondary control signal V is a control signal V received by a secondary main switch 13, the secondary main switch 13 being coupled to a secondary throw 12, the secondary throw 12 being coupled to a secondary bridge switch 14, the secondary bridge switch 14 being coupled to one of the flanking throws 12.

In one example of this rule that is depicted in FIG. 7, bridge switch 14A receives bridge control signal V1, and bridge control signal V1 is a secondary control signal V with respect to bridge switch 14A. The secondary control signal V1 is a control signal V received by a secondary main switch 13C, the secondary main switch 13C being coupled to a secondary throw 12C, the secondary throw 12C being coupled to a secondary bridge switch 14B (or 14C), the secondary bridge switch 14B (or 14C) being coupled to one of the flanking throws 12B (or 12A).

In another example of this rule that is depicted in FIG. 8, bridge switch 14A receives two bridge control signals V1 and V4, and both bridge control signals V1 and V4 are secondary control signals V with respect to bridge switch 14A. The secondary control signal V1 is a control signal V received by a secondary main switch 13E, the secondary main switch 13E being coupled to a secondary throw 12E, the secondary throw 12E being coupled to a secondary bridge switch 14E, the secondary bridge switch 14E being coupled to one of the flanking throws 12A. Similarly, the secondary control signal V4 is a control signal V received by a secondary main switch 13C, the secondary main switch 13C being coupled to a secondary throw 12C, the secondary throw 12C being coupled to a secondary bridge switch 14B, the secondary bridge switch 14B being coupled to one of the flanking throws 12B.

While the examples depicted in FIGS. 7 and 8 each designate bridge switch 14A as the primary bridge switch 14, the same rule applies to each other bridge switch 14. For example, if bridge switch 14B in FIG. 7 is designated as the primary bridge switch 14, then throw 12A and main switch 13A are secondary elements and control signal V2 is a secondary control signal V with respect to bridge switch 14B. For each bridge switch 14, the primary, secondary, and tertiary elements are identified and the secondary control signals V are identified.

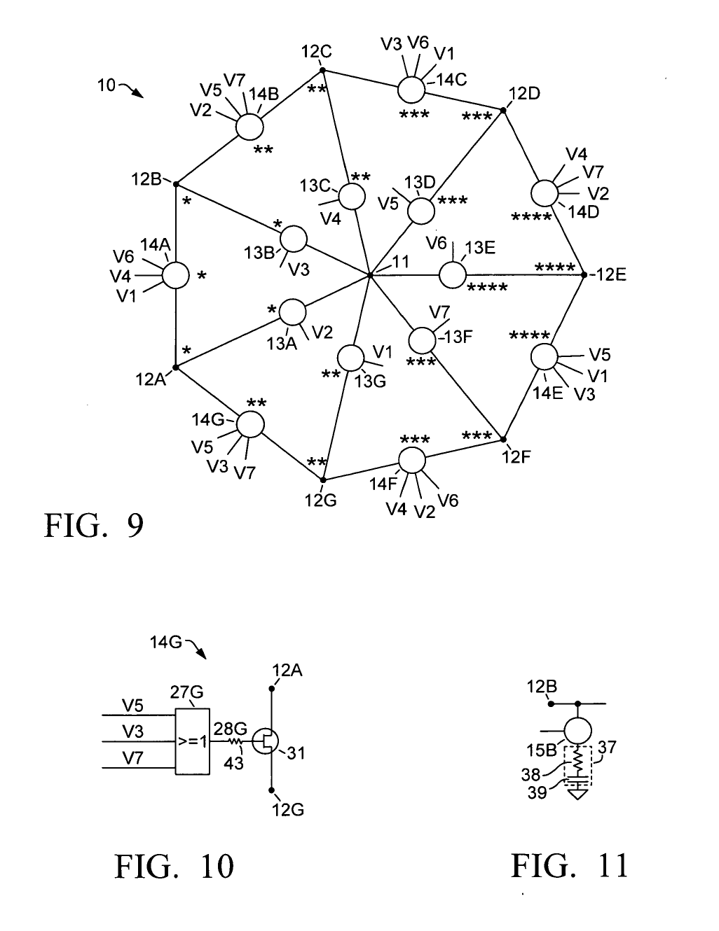

FIG. 9 depicts control signals V1-V7 and bridge control signals V1-V7 for the main switches 13 and the bridge switches 14 in a non-reflective SP7T switching device 10, in accordance with an embodiment. Except for the different numbers of elements, the embodiment of FIG. 9 is similar to that of FIGS. 7 and 8. As the number of throws 12 increases, the number of bridge control signals V increases. In the embodiment of FIG. 7, the secondary control signal comprises one secondary control signal V1. In the embodiment of FIG. 8, the secondary control signal comprises two secondary control signals V1 and V4. In the embodiment of FIG. 9, there are three bridge control signals V for each bridge switch 14: two secondary control signals V plus one quaternary control signal V. For example, for bridge switch 14A there are two secondary control signals V1, V4 and one quaternary control signal V6. In FIG. 9, asterisk symbols are used to indicate primary, secondary, tertiary, and quaternary elements with respect to bridge switch 14A.

The rule that was stated in connection with FIGS. 7 and 8 also applies to the SP7T embodiment of FIG. 9. Furthermore, we can state an extension of the rule that describes the association of a control signal V with a bridge switch 14, using the terminology of tertiary and quaternary elements. With respect to bridge switch 14A, for example, V1 and V4 are secondary signals V, throws 12C and 12G are secondary throws 12, and main switches 13C and 13G are secondary main switches. Tertiary elements include main switches 13D and 13F, throws 12D and 12F, and bridge switches 14C and 14F. Quaternary elements include main switch 13E, throw 12E, and bridge switches 14D and 14E. V6 is a quaternary control signal with respect to bridge switch 14A.

The extension of the rule is the following. For each bridge switch the at least one bridge control signal further comprises a quaternary control signal. The quaternary control signal is a control signal received by a quaternary main switch, the quaternary main switch being coupled to a quaternary throw, the quaternary throw being coupled to a quaternary bridge switch, the quaternary bridge switch being coupled to a tertiary throw, the tertiary throw being coupled to a tertiary bridge switch, the tertiary bridge switch being coupled to the secondary throw. For example, with respect to bridge switch 14A in FIG. 9, V6 is a quaternary control signal. Quaternary control signal V6 is a control signal V received by quaternary main switch 13E which is coupled to quaternary throw 12E. Quaternary throw 12E is coupled to two quaternary bridge switches 14D and 14E. Quaternary bridge switch 14D is coupled to tertiary throw 12D which is coupled to tertiary bridge switch 14C which is coupled to secondary throw 12C. Quaternary bridge switch 14E is coupled to tertiary throw 12F which is coupled to tertiary bridge switch 14F which is coupled to secondary throw 12G.

In the SP7T embodiment of FIG. 9, for each bridge switch 14 the quaternary control signal comprises one quaternary control signal V. In an SP9T embodiment similar to the SP7T embodiment of FIG. 9, there are two quaternary control signals V for each bridge switch 14 (not depicted). A non-reflective SPNT switch 10 as described herein can have any number of throws 12, such as 11 or 13 or 15 throws 12. In embodiments where each bridge control signal is one of the control signals V, such as the embodiments of FIGS. 7, 8 and 9, the number of bridge control signals V increases as the number of throws 12 increases. (Typically there is an odd number of throws 12, as described in connection with FIG. 4, but the number of throws 12 may be even as in the embodiment of FIG. 19.)

In switching devices 10 where each bridge switch 14 receives two or more bridge control signals V, the bridge control signals V may be combined using a logic gate so that the output of the logic gate controls a switching element within the bridge switch 14. FIG. 10 depicts a bridge switch 14G comprising a switching element 31 and a logic gate 27G that receives three bridge control signals V5, V3, and V7, in accordance with an embodiment. Logic gate 27G generates an output signal 28G that is received by switching element 31 through a gate resistor 43. In the embodiment of FIG. 10, logic gate 27G is an OR gate and switching element 31 uses positive logic.

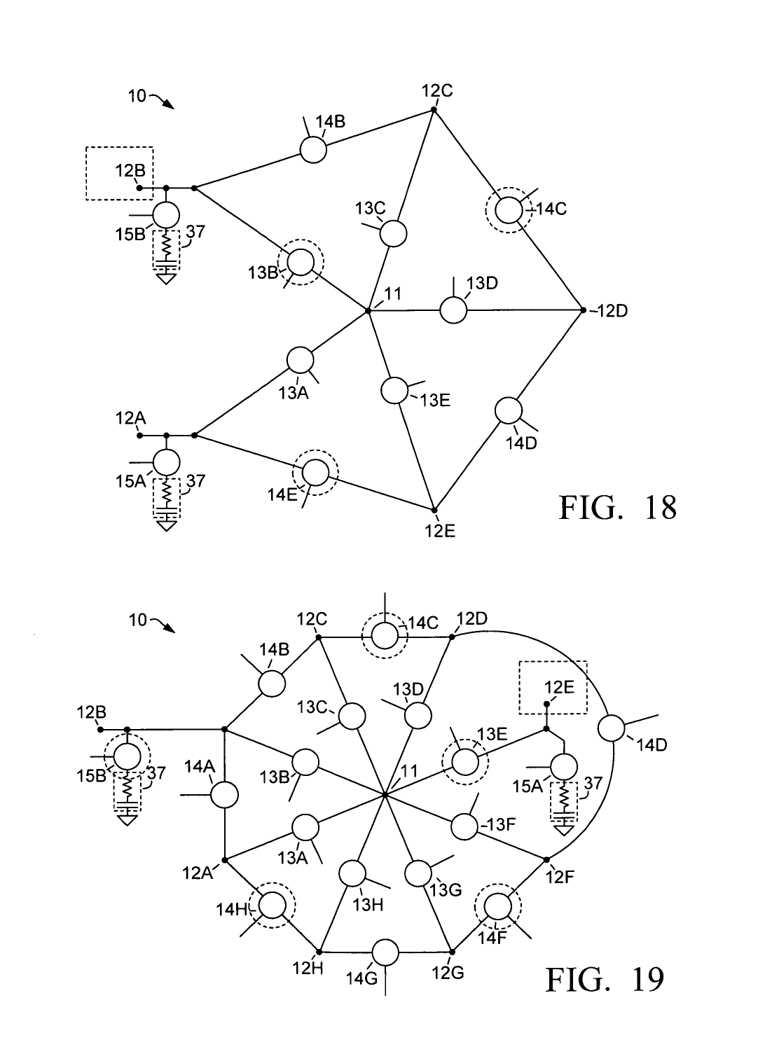

FIG. 11 depicts a termination 37 that includes a resistor 38 and a capacitor 39. The termination 37 depicted in FIG. 11 is discussed in connection with FIGS. 18 and 19.

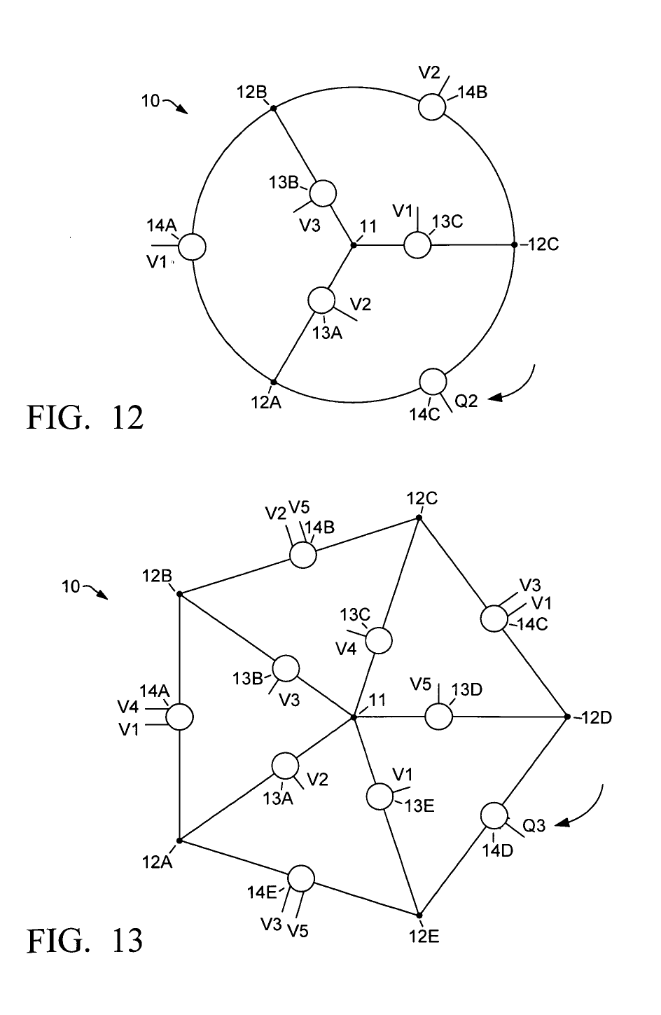

FIGS. 12 and 13 depict switching devices 10 in which some of the bridge control signals are control signals V and other bridge control signals, labelled Q, are separate from control signals V. In other words, the bridge control signals of FIGS. 12 and 13 include a mixture of signals V and Q. FIG. 12 depicts control signals V1-V3 for the main switches 13 and bridge control signals V1, V2, Q2 for the bridge switches 14 in the SP3T switching device 10 of FIG. 1, in accordance with an embodiment. Bridge switches 14A, 14B, and 14C receive bridge control signals V1, V2, and Q2 respectively. Bridge control signals V1 and V2 are the same as the control signals V1 and V2 received by main switches 13C and 13A, whereas bridge control signal Q2 (curved arrow) is separate from each control signal V. FIG. 13 depicts control signals V1-V5 for the main switches 13 and bridge control signals V1-V5, Q3 for the bridge switches 14 in the SP5T switching device 10 of FIG. 2, in accordance with an embodiment. Bridge switches 14A, 14B, 14C and 14E each receive two bridge control signals V that are the same as the control signals V received by main switches 13A-13E. Bridge switch 14D, however, receives bridge control signal Q3 (curved arrow) which is separate from each control signal V1-V5.

The main switches 13 and the bridge switches 14 for the embodiments described herein may be realized in a variety of ways. Both types of switches may be realized using series switching elements or variable shunt elements or a configuration that combines series switching elements and variable shunt elements. Bridge switches 14 and main switches 13 may be realized using these configurations: series-only, series-shunt-series, or variable shunt combined with transmission lines. Within a switching device 10, different configurations may be used for individual main switches 13 and for individual bridge switches 14. Termination switches 15, described in connection with FIGS. 18 and 19, may be realized using similar configurations. FIGS. 14-17 depict examples of switch configurations. In other embodiments, a main switch 13 or bridge switch 14 may include additional circuit elements such as a resistor, capacitor, or inductor, or an additional circuit element such as a capacitor may be connected in series between a main switch 13 or bridge switch 14 and a pole 11 or throw 12.

FIG. 14 depicts a bridge switch 14 having a series-only configuration, in accordance with an embodiment. The bridge switch 14 includes three switching elements 31, each of the three switching elements 31 receiving the same control signal V. In the embodiment of FIG. 14, each switching element 31 is a series switching element. FIG. 15 depicts a non-reflective SP3T switching device 10 that uses multi-gate transistors for the main switches 13 and the bridge switches 14, in accordance with an embodiment. In the series-only embodiment of FIG. 15, each main switch 13 includes one triple-gate transistor and each bridge switch 14 includes two triple-gate transistors. Control signals V1-V3 control main switches 13 and bridge switches 14, as in the embodiment of FIG. 7.

FIG. 16 depicts a bridge switch 14 having a series-shunt-series configuration, in accordance with an embodiment. The bridge switch 14 includes a first set of series switching elements 31, a set of variable shunt elements 35, a second set of series switching elements 31, and an inverter 45. Each variable shunt element 35 includes a switching element 31 coupled to a reference potential, which is this embodiment is ground. Each set of series switching elements 31 receives bridge control signal V, and variable shunt elements 35 receive from inverter 45 the complement of bridge control signal V. Compared to the embodiment of FIG. 16, the series-only configuration of FIG. 14 may provide higher isolation at lower frequency and higher power handling, but with the cost of more insertion loss. The configuration of FIG. 16 uses variable shunt elements 35 to provide high isolation, but with the cost of a more complex circuit with more components.

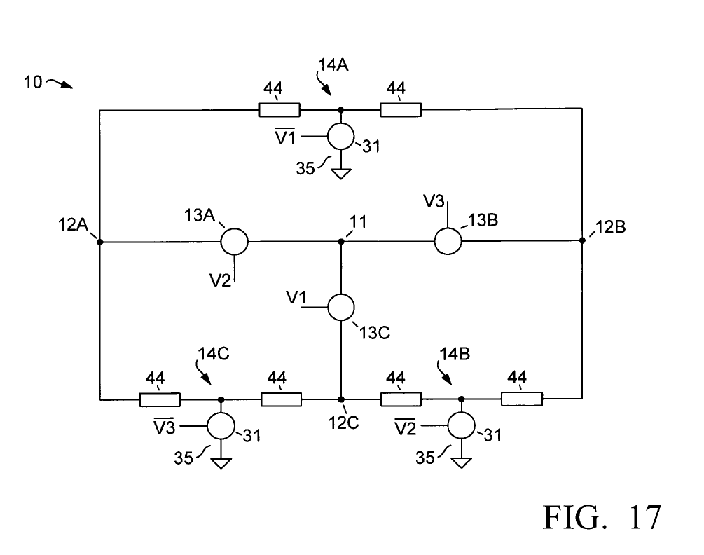

FIG. 17 depicts a non-reflective SP3T switching device 10 that uses variable shunts 35 combined with transmission lines 44 for the bridge switches 14, in accordance with an embodiment. The embodiment of FIG. 17 is especially useful at high frequency, such as frequencies above 1 GHz. Each transmission line 44 has a length that equals one-quarter of the wavelength for the frequency band of the signal that is conducted by the transmission line 44. Main switches 13C, 13A, 13B receive control signals V1, V2, V3. Within the variable shunt 35 in each bridge switch 14, switching element 31 receives a bridge control signal which is the complement of one of the control signals V. Thus, bridge switch 14A receives the complement of control signal V1, bridge switch 14B receives the complement of control signal V2, and bridge switch 14C receives the complement of control signal V3. In another embodiment, bridge switches 14A-14C might receive bridge control signals Q that are separate from control signals V.

Embodiments described herein may be implemented as integrated circuits or using discrete components. Bridge switches 14 and main switches 13 may be implemented as semiconductor switching elements such as diodes or PIN diodes or bipolar transistors or field effect transistors (FET). For example, switching elements may be implemented as silicon based (Si-based) FETs or as gallium arsenide based (GaAs-based) FETs. Si-based FETs include silicon junction FET (JFET), silicon metal-semiconductor FET (MESFET), silicon germanium bipolar CMOS (SiGe BiCMOS), and various types of silicon metal-oxide-semiconductor FET (MOSFET) such as NMOS, CMOS, silicon on sapphire (SOS), and silicon on insulator (SOI). GaAs-based FETs include GaAs JFET, GaAs MESFET, GaAs pseudomorphic high electron mobility transistor (pHEMT), GaAs metamorphic high electron mobility transistor (mHEMT), and GaAs heterostructure FET (HFET).

Embodiments such as those described in FIGS. 14-17 may be combined with embodiments such as that of FIG. 10. In the bridge switch 14 embodiment of FIG. 10, a logic gate 27 generates an output signal 28 that is received by a switching element 31.

Tables 3-6 present the results of simulating two microwave circuit designs. Each table presents the return loss values for a range of frequencies for an individual pole 11 or throw 12. One of the simulated designs (NON-REFLECT) is the embodiment of FIG. 15. The other simulated design (STAR) is a simple star-topology SP3T switching device that uses one triple-gate transistor for each main switch 13. In the STAR design, bridge switches 14 are absent and there is no conductor or other connection between individual throws 12. In the STAR design, the pole 11 is non-reflective and the active throw 12 is non-reflective, but the other (non-active) throws 12 are reflective. Each simulation assumes that main switch 13C is in the ON condition, so that throw 12C and pole 11 are active, while throws 12A and 12B are non-active.

The simulation results for the design of FIG. 15 (NON-REFLECT) show very low return loss for pole 11 and for each of the throws 12, including the non-active throws 12A and 12B. The simulation results for the STAR design, in contrast, show high return loss for the non-active throws 12A and 12B. Throughout the frequency range, the NON-REFLECT design shows much lower return loss than the STAR design. For example, throw 12A at 3.5 GHz shows a return loss of −0.8 dB in the STAR design and −40 dB in the NON-REFLECT design. Simulation of other SPNT embodiments similar to that of FIG. 15, such as SP5T, SP7T, and SP9T, yielded similar results with very low return loss values.

The simulation results of Tables 3-6 demonstrate that embodiments described in this application provide an effective and practical way to achieve a non-reflective SPNT switching device.

TABLE 3

| | STAR | NON-REFLECT |
|---|---|---|
| | return loss | return loss |
| frequency | (dB) | (dB) |
| (GHz) | pole 11 | pole 11 |
| 0.1 | −32 | −32 |
| 1.0 | −34 | −36 |
| 2.0 | −34 | −47 |
| 3.0 | −32 | −31 |
| 3.5 | −30 | −26 |
| 4.0 | −27 | −24 |
| 5.0 | −23 | −18 |
| 6.0 | −18 | −14 |

TABLE 4

| | STAR | NON-REFLECT |
|---|---|---|
| | return loss | return loss |
| frequency | (dB) | (dB) |
| (GHz) | throw 12C | throw 12C |
| 0.1 | −32 | −32 |
| 1.0 | −32 | −35 |
| 2.0 | −29 | −41 |
| 3.0 | −27 | −33 |
| 3.5 | −25 | −28 |
| 4.0 | −24 | −25 |
| 5.0 | −21 | −20 |
| 6.0 | −18 | −16 |

TABLE 5

| | STAR | NON-REFLECT |
|---|---|---|
| | return loss | return loss |
| frequency | (dB) | (dB) |
| (GHz) | throw 12A | throw 12A |
| 0.1 | −0.3 | −24 |
| 1.0 | −0.4 | −25 |
| 2.0 | −0.5 | −27 |
| 3.0 | −0.7 | −35 |
| 3.5 | −0.8 | −40 |
| 4.0 | −0.9 | −32 |
| 5.0 | −1.3 | −22 |
| 6.0 | −1.8 | −17 |

TABLE 6

| | STAR | NON-REFLECT |
|---|---|---|
| | return loss | return loss |
| frequency | (dB) | (dB) |
| (GHz) | throw 12B | throw 12B |
| 0.1 | −0.3 | 24 |
| 1.0 | −0.3 | 24 |
| 2.0 | −0.4 | 27 |
| 3.0 | −0.5 | 33 |
| 3.5 | −0.6 | 45 |
| 4.0 | −0.8 | 36 |
| 5.0 | −1.1 | 24 |
| 6.0 | −1.6 | 18 |

Bridge switches 14 are used for non-reflectivity in each of the embodiments described above. An alternative method of making a non-reflective switching device is to incorporate at each terminal (eg a throw) a switched termination that provides a matched impedance. Typically a 50 Ohm termination is used in microwave systems and a 75 Ohm termination is used in television transmission systems. The switched termination may be either a series termination or a shunt termination; use of a series termination may result in greater insertion loss. A shunt termination typically includes a resistor coupled between a switching element and a reference potential such as ground. In semiconductor switches using materials such as gallium arsenide (GaAs) with positive control voltages, a shunt termination may also include a capacitor. FIG. 11 depicts a termination 37 that includes a resistor 38 and a capacitor 39. The termination 37 is operably coupled to a throw 12B through a termination switch 15B. The structure of termination 37 may differ in other embodiments.

FIGS. 18 and 19 depict embodiments that use a combination of bridge switches 14 and terminations 37 for non-reflectivity. FIG. 18 depicts a non-reflective SP5T switching device 10 comprising one pole 11, five throws 12, five main switches 13, four bridge switches 14, two terminations 37, and two termination switches 15, in accordance with an embodiment. The embodiment of FIG. 18 is similar to that of FIG. 2, with two differences: (1) removal of one bridge switch 14A; and (2) addition of terminations 37 operably coupled to throws 12B and 12A through termination switches 15B and 15A. In this description and in the appended claims, a termination switch 15 is a switch coupled to a termination 37, and use of the adjective “termination” does not imply any special attributes for a termination switch 15. Throws 12B and 12A are half-bridged throws 12, while each of the remaining three throws 12C, 12D, 12E is a bridged throw 12. In the embodiment of FIG. 18, the throw count (number of throws 12) is five, the main switch count (number of main switches 13) equals the throw count, and the bridge switch count (number of bridge switches 14) equals the throw count minus one.

The bridged throws 12C-12E in the embodiment of FIG. 18 are similar to the throws 12 in the embodiments of FIGS. 1-13. Thus, each bridged throw 12 is operably coupled to first and second adjacent throws 12 through first and second adjacent bridge switches 14, as described in connection with FIG. 1. Each of the half-bridged throws 12B and 12A is operably coupled to a third adjacent throw 12 through a bridge switch 14 and is operably coupled to a termination 37 through a termination switch 15. Thus, half-bridged throw 12B is operably coupled to adjacent throw 12C through bridge switch 14B and is also operably coupled to a termination 37 through termination switch 15B. Similarly, half-bridged throw 12A is operably coupled to adjacent throw 12E through bridge switch 14E and is also operably coupled to a termination 37 through termination switch 15A.

Table 7 indicates the five possible sets of states for the main switches 13, the bridge switches 14, and the termination switches 15 in the embodiment of FIG. 18. For each switch, a plus symbol (+) indicates the first state and a minus symbol (−) indicates the second state. When a main switch 13 has the first state, the throw 12 that is coupled to that main switch 13 is the active throw. The set of states depicted in FIG. 18 corresponds to row 2 in Table 7. A dashed circle indicates the first state, absence of a dashed circle indicates the second state, and a dashed rectangle indicates the active throw 12.

TABLE 7

| | 13A | 13B | 13C | 13D | 13E | 14B | 14C | 14D | 14E | 15A | 15B |
|---|---|---|---|---|---|---|---|---|---|---|---|
| 1 | + | − | − | − | − | + | − | + | − | − | − |
| 2 | − | + | − | − | − | − | + | − | + | − | − |
| 3 | − | − | + | − | − | − | − | + | − | + | + |
| 4 | − | − | − | + | − | + | − | − | + | − | − |
| 5 | − | − | − | − | + | − | + | − | − | + | + |

FIG. 19 depicts a non-reflective SP8T switching device 10 comprising one pole 11, eight throws 12, eight main switches 13, seven bridge switches 14, two terminations 37, and two termination switches 15, in accordance with an embodiment. As described in connection with FIG. 4, most of the non-reflective switching devices 10 described herein include an odd number of throws 12. An odd number of throws 12 allows all of the non-active throws 12 to be coupled in pairs through bridge switches 14. The embodiment of FIG. 19 is different, as it includes an even number of throws 12. Throw 12E is an unbridged throw 12; in other words, throw 12E is not operably coupled to any other throw 12 through any bridge switch 14. Each of the other throws 12A-12D and 12F-12H is a bridged throw 12. Unbridged throw 12E is operably coupled to a termination 37 through a termination switch 15A, and bridged throw 12B is operably coupled to a termination 37 through a termination switch 15B. In the embodiment of FIG. 19, the throw count (number of throws 12) is eight, the main switch count (number of main switches 13) equals the throw count, and the bridge switch count (number of bridge switches 14) equals the throw count minus one.

The bridged throws 12A-12D and 12F-12H in the embodiment of FIG. 19 are similar to the throws 12 in the embodiments of FIGS. 1-13. Thus, each bridged throw 12 is operably coupled to first and second adjacent throws 12 through first and second adjacent bridge switches 14, as described in connection with FIG. 1. In the embodiment depicted in FIG. 19, a termination 37 is operably coupled to bridged throw 12B. In another embodiment, termination 37 may be operably coupled to any other of the bridged throws 12A-12D and 12F-12H instead of bridged throw 12B.

Table 8 indicates the eight possible sets of states for the main switches 13, the bridge switches 14, and the termination switches 15 in the embodiment of FIG. 19. For each switch, a plus symbol (+) indicates the first state and a minus symbol (−) indicates the second state. When a main switch 13 has the first state, the throw 12 that is coupled to that main switch 13 is the active throw. The set of states depicted in FIG. 19 corresponds to row 5 in Table 8. A dashed circle indicates the first state, absence of a dashed circle indicates the second state, and a dashed rectangle indicates the active throw 12.

TABLE 8

| | 13A | 13B | 13C | 13D | 13E | 13F | 13G | 13H |
|---|---|---|---|---|---|---|---|---|
| 1 | + | − | − | − | − | − | − | − |
| 2 | − | + | − | − | − | − | − | − |
| 3 | − | − | + | − | − | − | − | − |
| 4 | − | − | − | + | − | − | − | − |
| 5 | − | − | − | − | + | − | − | − |
| 6 | − | − | − | − | − | + | − | − |
| 7 | − | − | − | − | − | − | + | − |
| 8 | − | − | − | − | − | − | − | + |

| | 14A | 14B | 14C | 14D | 14F | 14G | 14H | 15A | 15B |
|---|---|---|---|---|---|---|---|---|---|
| 1 | − | + | − | + | − | + | − | + | − |
| 2 | − | − | + | − | + | − | + | + | − |
| 3 | + | − | − | + | − | + | − | + | − |
| 4 | − | + | − | − | + | − | + | + | − |
| 5 | − | − | + | − | + | − | + | − | + |
| 6 | + | − | + | − | − | + | − | + | − |
| 7 | − | + | − | + | − | − | + | + | − |
| 8 | + | − | + | − | + | − | − | + | − |

Although we have described in detail various embodiments, other embodiments and modifications will be apparent to those of skill in the art in light of this text and accompanying drawings. The following claims are intended to include all such embodiments, modifications and equivalents.

What is claimed is:

1. A switching device comprising:
one pole;
at least three throws, each throw having a first adjacent throw and a second adjacent throw, the first adjacent throw and the second adjacent throw being two of the at least three throws;
a plurality of main switches, a main switch count equaling a throw count, each main switch being coupled between the pole and one of the throws; and
a plurality of bridge switches, a bridge switch count equaling the throw count, wherein for each throw the throw is operably coupled to the first adjacent throw through a first adjacent bridge switch and is operably coupled to the second adjacent throw through a second adjacent bridge switch, the first adjacent bridge switch being one of the bridge switches, the second adjacent bridge switch being one of the bridge switches, each bridge switch being coupled to two flanking throws, the flanking throws being two of the at least three throws.

2. The switching device of claim 1,
wherein one main switch has a first state and each other main switch has a second state, the one main switch being coupled to an active throw, the active throw being one of the at least three throws;
wherein for the active throw the first adjacent bridge switch has the second state and the second adjacent bridge switch has the second state; and
wherein for each other throw one of the first adjacent bridge switch and the second adjacent bridge switch has the first state and one of the first adjacent bridge switch and the second adjacent bridge switch has the second state.

3. The switching device of claim 1,
wherein the at least three throws comprise at least five throws.

4. The switching device of claim 3,
wherein one main switch has a first state and each other main switch has a second state, the one main switch being coupled to an active throw, the active throw being one of the at least three throws;
wherein for the active throw the first adjacent bridge switch has the second state and the second adjacent bridge switch has the second state; and
wherein for each other throw one of the first adjacent bridge switch and the second adjacent bridge switch has the first state and one of the first adjacent bridge switch and the second adjacent bridge switch has the second state.

5. The switching device of claim 1,
wherein each main switch receives a control signal, the control signal being separate for each main switch; and
wherein each bridge switch receives a bridge control signal, each bridge control signal being separate from each control signal.

6. The switching device of claim 1,
wherein each main switch receives a control signal, the control signal being separate for each main switch; and
wherein each bridge switch receives a bridge control signal, at least one bridge control signal being separate from each control signal.

7. The switching device of claim 1,
wherein each main switch receives a control signal, the control signal being separate for each main switch; and
wherein each bridge switch receives a bridge control signal, at least one bridge control signal being complementary to one of the control signals.

8. The switching device of claim 1,
wherein each main switch receives a control signal, the control signal being separate for each main switch; and
wherein each bridge switch receives at least one bridge control signal, each bridge control signal being one of the control signals.

9. The switching device of claim 1,
wherein each main switch receives a control signal, the control signal being separate for each main switch; and
wherein each bridge switch receives at least one bridge control signal, wherein for each bridge switch the at least one bridge control signal comprises a secondary control signal, the secondary control signal being the control signal received by a secondary main switch, the secondary main switch being coupled to a secondary throw, the secondary throw being coupled to a secondary bridge switch, the secondary bridge switch being coupled to one of the flanking throws.

10. The switching device of claim 9, wherein the secondary control signal comprises one secondary control signal.

11. The switching device of claim 9, wherein the secondary control signal comprises two secondary control signals.

12. The switching device of claim 9,
wherein for each bridge switch the at least one bridge control signal further comprises a quaternary control signal, the quaternary control signal being the control signal received by a quaternary main switch, the quaternary main switch being coupled to a quaternary throw, the quaternary throw being coupled to a quaternary bridge switch, the quaternary bridge switch being coupled to a tertiary throw, the tertiary throw being coupled to a tertiary bridge switch, the tertiary bridge switch being coupled to the secondary throw.

13. The switching device of claim 12, wherein the quaternary control signal comprises one quaternary control signal.

14. The switching device of claim 12, wherein the quaternary control signal comprises two quaternary control signals.

15. The switching device of claim 9, wherein each bridge switch comprises a logic gate and a switching element, the logic gate receiving the at least one bridge control signal for the bridge switch, the logic gate generating an output signal, the switching element receiving the output signal.

16. A switching device comprising:
one pole;
at least three throws, two of the throws being half-bridged throws, each throw that is not a half-bridged throw being a bridged throw, each throw having a first adjacent throw, each bridged throw having a second adjacent throw, the first adjacent throw and the second adjacent throw being two of the at least three throws;
a plurality of main switches, a main switch count equaling a throw count, each main switch being coupled between the pole and one of the throws; and
a plurality of bridge switches, a bridge switch count equaling the throw count minus one, wherein for each throw the throw is operably coupled to the first adjacent throw through a first adjacent bridge switch, wherein for each bridged throw the bridged throw is operably coupled to the second adjacent throw through a second adjacent bridge switch, the first adjacent bridge switch being one of the bridge switches, the second adjacent bridge switch being one of the bridge switches, each bridge switch being coupled to two flanking throws, the flanking throws being two of the at least three throws, wherein for each half-bridged throw the half-bridged throw is operably coupled to a termination through a termination switch.

17. The switching device of claim 16,
wherein the at least three throws comprise at least five throws.

18. The switching device of claim 17,
wherein one main switch has a first state and each other main switch has a second state, the one main switch being coupled to an active throw, the active throw being one of the half-bridged throws;
wherein for the active throw the first adjacent bridge switch has the second state;
wherein each termination switch has the second state; and
wherein for each bridged throw one of the first adjacent bridge switch and the second adjacent bridge switch has the first state and one of the first adjacent bridge switch and the second adjacent bridge switch has the second state.

19. The switching device of claim 17,
wherein one main switch has a first state and each other main switch has a second state, the one main switch being coupled to an active throw, the active throw being one of the bridged throws;
wherein for the active throw the first adjacent bridge switch has the second state and the second adjacent bridge switch has the second state;
wherein for each other bridged throw one of the first adjacent bridge switch and the second adjacent bridge switch has the first state and one of the first adjacent bridge switch and the second adjacent bridge switch has the second state; and
wherein the first adjacent throw is one of the half-bridged throws and each termination switch has the first state.

20. The switching device of claim 17,
wherein one main switch has a first state and each other main switch has a second state, the one main switch being coupled to an active throw, the active throw being one of the bridged throws;
wherein for the active throw the first adjacent bridge switch has the second state and the second adjacent bridge switch has the second state;
wherein for each other bridged throw one of the first adjacent bridge switch and the second adjacent bridge switch has the first state and one of the first adjacent bridge switch and the second adjacent bridge switch has the second state; and
wherein the first adjacent throw is one of the bridged throws and each termination switch has the second state.

21. A switching device comprising:
one pole;
at least four throws, one of the throws being an unbridged throw, each throw that is not an unbridged throw being a bridged throw, each bridged throw having a first adjacent throw and a second adjacent throw, the first adjacent throw and the second adjacent throw being two of the at least three bridged throws;
a plurality of main switches, a main switch count equaling a throw count, each main switch being coupled between the pole and one of the throws; and
a plurality of bridge switches, a bridge switch count equaling the throw count minus one, wherein for each bridged throw the bridged throw is operably coupled to the first adjacent throw through a first adjacent bridge switch and is operably coupled to the second adjacent throw through a second adjacent bridge switch, the first adjacent bridge switch being one of the bridge switches, the second adjacent bridge switch being one of the bridge switches, each bridge switch being coupled to two flanking throws, the flanking throws being two of the bridged throws, wherein the unbridged throw is operably coupled to a first termination through a first termination switch and one of the bridged throws is operably coupled to a second termination through a second termination switch.

22. The switching device of claim 21,
wherein the at least four throws comprise at least six throws.
